(19) United States
(12) Patent Application Publication
(10) Pub. No.: US 2006/0165463 A1
(43) Pub. Date: Jul. 27, 2006

(54) Wireless keyboard for hand-held computers

(76) Inventor: Michael Katz, Vancouver (CA)

Correspondence Address: Davis Wright Tremaine, 2600 Century Square, 1501 Fourth Avenue, Seattle, WA, 98101-1688, US

(21) Appl. No.: 10/500,693

(22) PCT Filed: Jan. 3, 2003
(86) PCT No.: PCT/CA03/00004

§ 371 Date: Jul. 2, 2005

(30) Foreign Application Priority Data
Jan. 4, 2002 (CA) 2,366,636

(51) Int. Cl. B41J 5/14

(52) U.S. Cl. 400/472

(57) ABSTRACT

Prior collapsible keyboards for personal digital assistants are overly complex and require different connecting hard-ware for different handheld devices. The present invention provides a folding keyboard for a hand-held computer or other information processing devices which folds up simply and in a small size and which is useful for touch typists. It communicates with the handheld device by a wireless connection which allows a single keyboard to be used with multiple types of handheld devices.

### TECHNICAL FIELD

The invention relates to keyboards, and in particular to a wireless keyboard particularly useful with personal digital assistants and other hand-held information processing devices and cellular telephones.

### BACKGROUND ART

Various hand-held computing devices have become popular as portable computers, personal organizers and as wireless communication devices due to their small size and portability. Such devices include the personal digital assistant (“PDA”) such as those manufactured by PALM™, HANDSPRING™, COMPAQ™, HEWLETT-PACKARD™, CASIO™ and SONY™, personal organizers, palm-size computers and internet-ready cellular telephones, as manufactured by MOTOROLA™, NOKIA™ and SIEMENS™ for example. These devices typically use a pen or stylus to either hand-write characters or select letters from a simulated keyboard by tapping on the screen. In the case of a simulated keyboard, the user has only one character-selecting element, so the data entry is very slow. In the case of hand-written characters, the computing device relies on handwriting recognition software to interpret the user's notations, and consequently there are frequent errors in data entry which must be corrected.

Computer users are most familiar with entering data into a computer by means of a keyboard. Indeed many computer users are touch typists who require a QWERTY keyboard, that is, a keyboard in which the keys are arranged in the universal arrangement, to type at full speed and efficiency. The lack of a standard keyboard greatly reduces the usefulness of hand-held devices for word processing, e-mail, internet access or software applications. However, carrying a standard size keyboard with a hand-held device would defeat its portability and size advantages, and a standard size keyboard cannot be reduced to a size comparable to the size of a PDA or other hand-held computer without folding and/or collapsing the keyboard.

Collapsible keyboards have therefore been developed for PDA's and similar devices. See, for example, U.S. Pat. No. 6,174,097 issued Jan. 16, 2001 to Simon Daniel entitled “Collapsible Keyboard”, which keyboard is sold under the trademark STOWAWAY by Think Outside, Inc. While such a device provides a collapsible full-size keyboard for a PDA or cellphone, it is complex to manufacture due to its concertina-like structure, the need for three folding axes and multiple slidable keys and spring connections to effect collapsing. Also, the PDA connects to the keyboard through a built-in docking station which requires a different design for each type of hand-held device. To connect the PDA with the STOWAWAY keyboard, the connector of the PDA slides into a corresponding connector on the keyboard, so different hardware connections must be provided for the keyboard to be used with different devices. More than 20 different keyboards are therefore required for the different hand-held devices.

There is therefore a need for a portable, folding keyboard for use with hand-held computers which functions as a full-size keyboard and which can be readily used with different devices.

### DISCLOSURE OF INVENTION

The present invention provides a wireless keyboard for use with a handheld computer wherein the handheld computer comprises an infra-red communications port, the wireless keyboard comprising a keyboard body having a plurality of keys, an infra-red communications port and means for supporting the handheld computer in a position whereby the infra-red ports of the keyboard and handheld are able to communicate with one another.

The present invention further provides a folding wireless keyboard comprising a plurality of keys generally corresponding to the keys of a standard personal computer keyboard comprising three parallel, lengthwise rows of keys comprising a central row, an upper row and a lower row, and comprising two halves hingedly connected along a fold line extending transversely across said keyboard perpendicular to the direction of the rows, each half thereby comprising a portion of said plurality of keys, whereby the keyboard is folded from a first open position in which the plurality of keys forms a generally standard personal computer keyboard, to a closed position in which the two halves are in opposed parallel relationship; and wherein the central row comprises keys of standard size, and the upper and lower rows comprise keys which are reduced in size in the transverse direction. Preferably the surfaces of the upper and lower rows of keys are configured to redirect a typist's finger to the center of the reduced size key.

### BRIEF DESCRIPTION OF DRAWINGS

In drawings which disclose a preferred embodiment of the invention:

FIG. 1 is a perspective view of the keyboard of the invention, fully folded;

FIG. 2 is a bottom view of the keyboard of the invention, in open position;

FIG. 3 is a top view of the keyboard of the invention, in open position;

FIG. 4 is a top view of the invention, fully open in which a PDA has been attached but not slid to the locked operating position;

FIG. 5 is a perspective view of the invention, fully open in which a PDA is attached in a first operating configuration;

FIGS. 6, 7 and 8 are elevation views of three alternate hinge structures;

FIG. 9 is an exploded perspective view of a stylus stand for use in the invention;

FIG. 10 is a perspective view of the invention, fully open in which a PDA is mounted on a stand in a second operating configuration;

FIG. 11 is a perspective view of the folded keyboard of the invention, and the mounting stand in separated configuration;

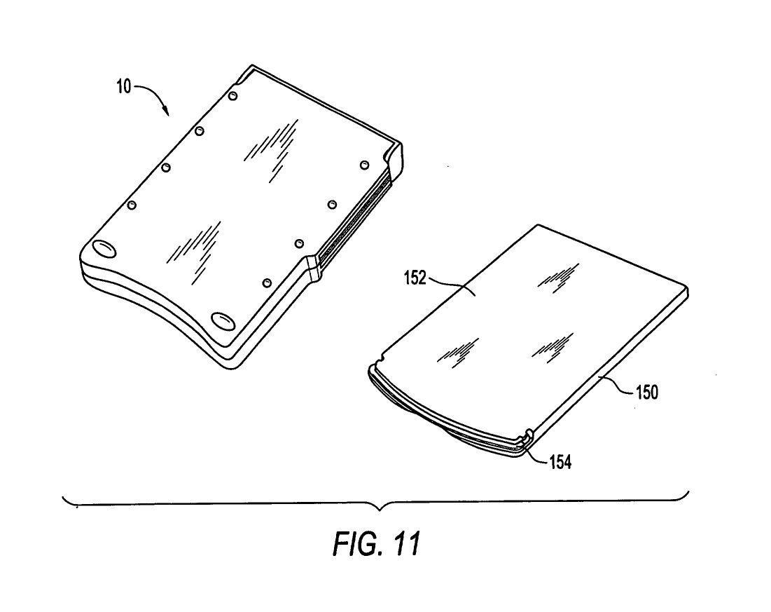

FIG. 12 is a perspective view of the folded keyboard of the invention, and the mounting stand folded in hinged attachment;

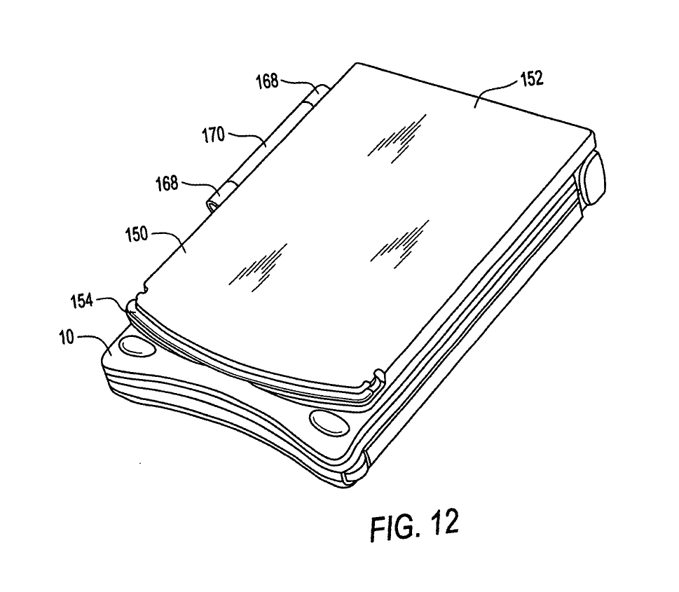

FIG. 13 is a perspective view of the folded keyboard of the invention, and the mounting stand in open hinged attachment;

FIG. 14 is a detail perspective view of the hinged attachment of the mounting stand to a PDA;

FIG. 15 is a detail top view of the fold region of the keyboard of the invention;

FIG. 16 is a detail front view of the folded keyboard with the hinge partially cut away for purposes of illustration;

FIG. 17 is a rear view of the keyboard in open position;

FIG. 18 is a detail rear view of the keyboard in open position partially in cross-section along lines A-A of FIG. 15 for purposes of illustration;

FIG. 19 is a detail rear view of the keyboard in open position with the hinge partially in cross-section along lines B-B of FIG. 15 for purposes of illustration;

FIG. 20 is a cross-section view of the keyboard in open position taken along lines C-C of FIG. 15;

FIG. 21 is a perspective view of the mounting stand for use in the invention;

FIG. 22 is a perspective view of a custom sled for use in the invention;

FIG. 23 is a cross-section detail view of the gear elements of the keyboard in open position taken along lines D-D of FIG. 15;

FIG. 24 is a cross-section detail view of the gear elements of the keyboard as shown in FIG. 23 in closed position;

FIG. 25 is a cross-section detail view of the keyboard in open position taken along lines E-E of FIG. 15; and

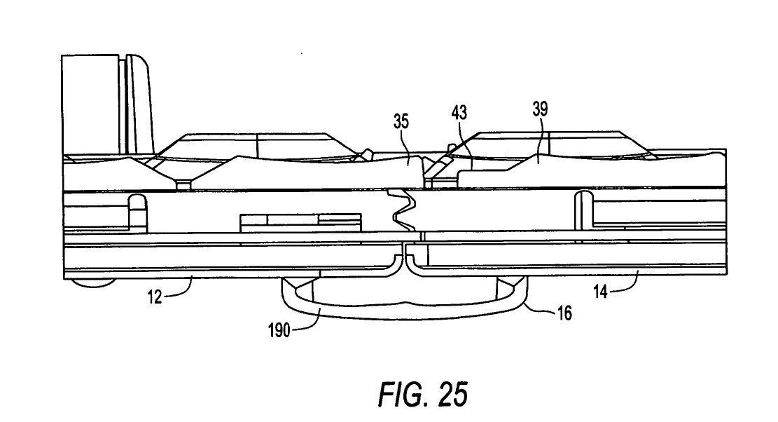

FIG. 26 is a cross-section detail view of the keyboard as shown in FIG. 25 in closed position.

### BEST MODES(S) FOR CARRYING OUT THE INVENTION

For purposes of this disclosure, the term “handheld computer” will be understood to refer to all forms of hand-held devices which have information processing capability, including personal digital assistants, personal organizers, palm-size computers and internet-ready cellular telephones

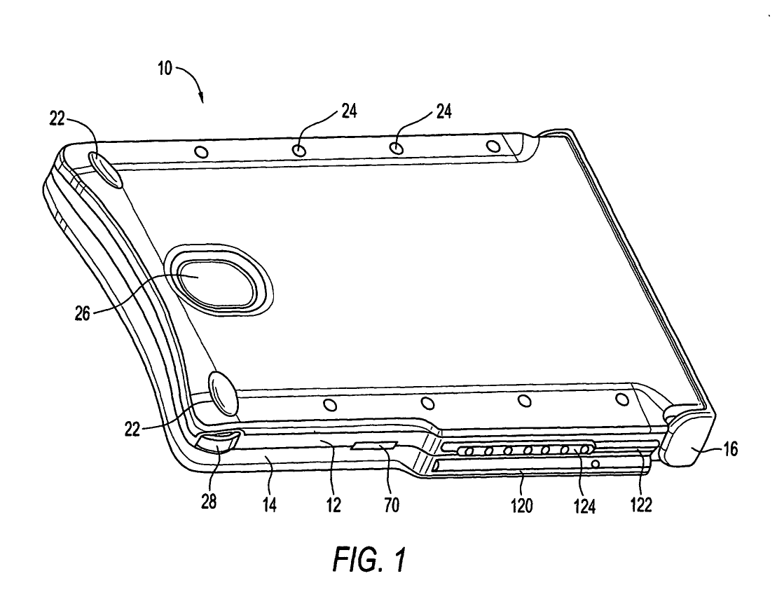

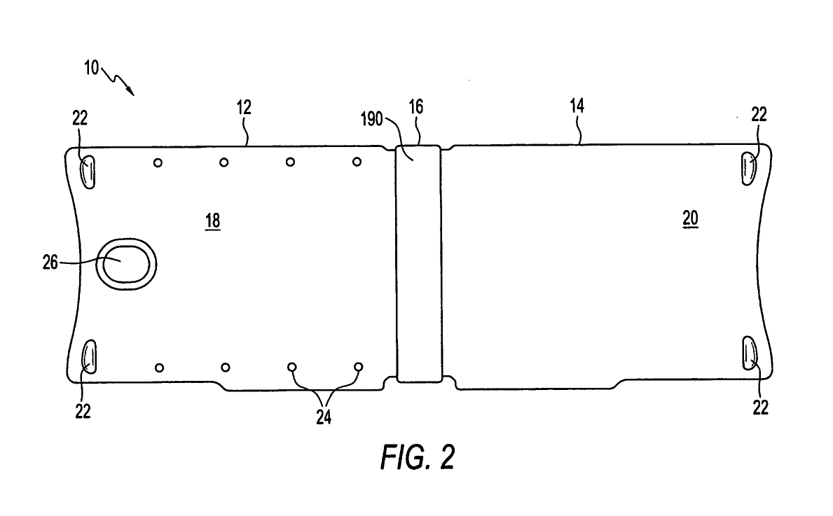

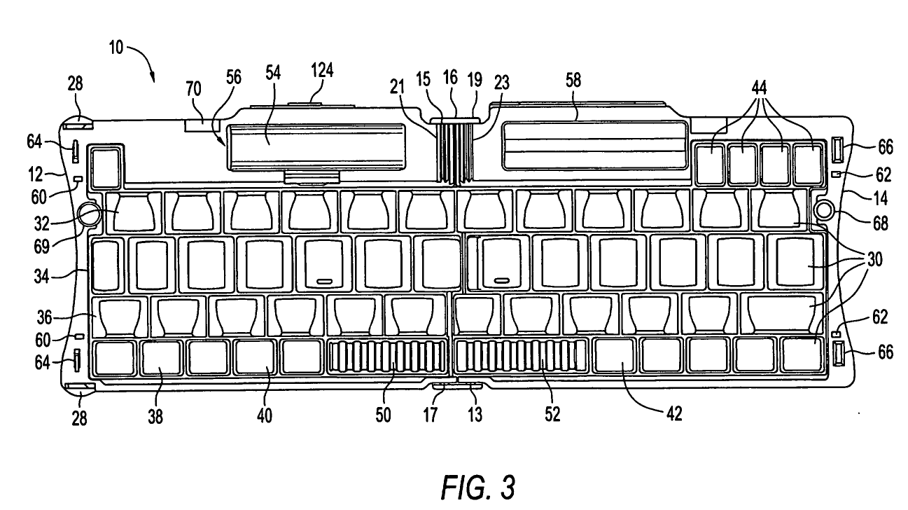

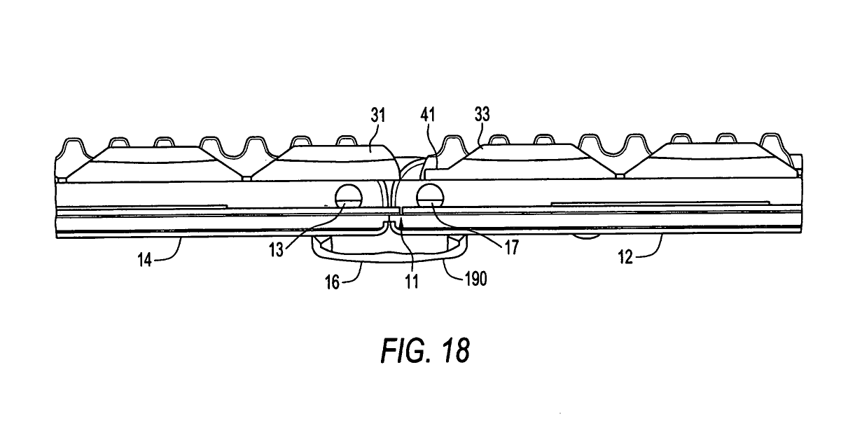

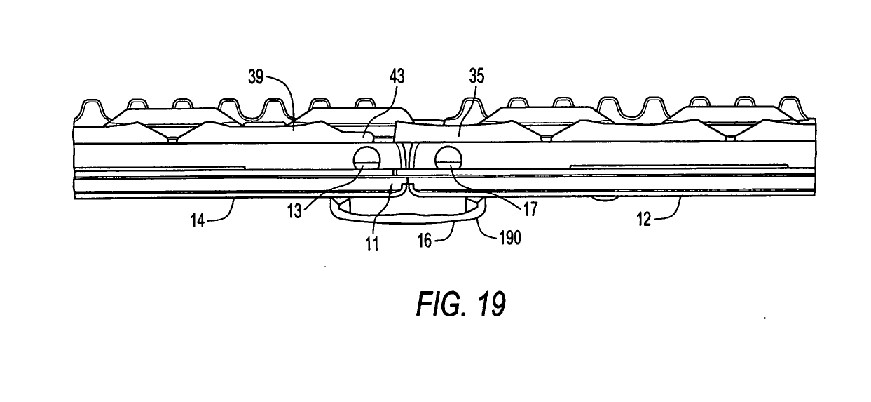

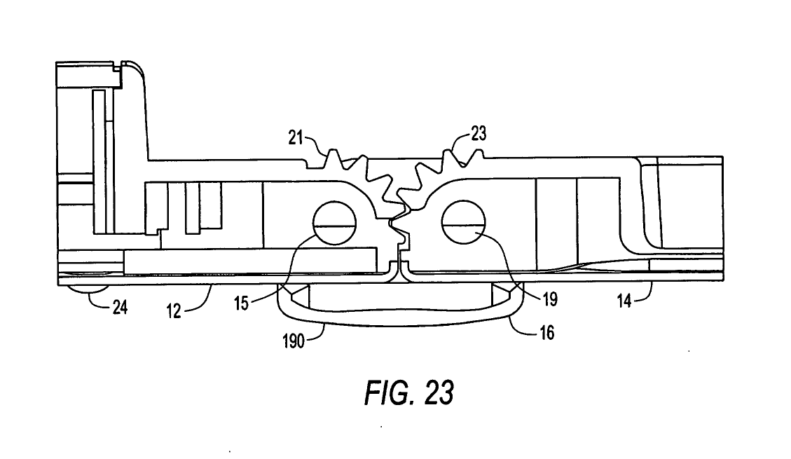

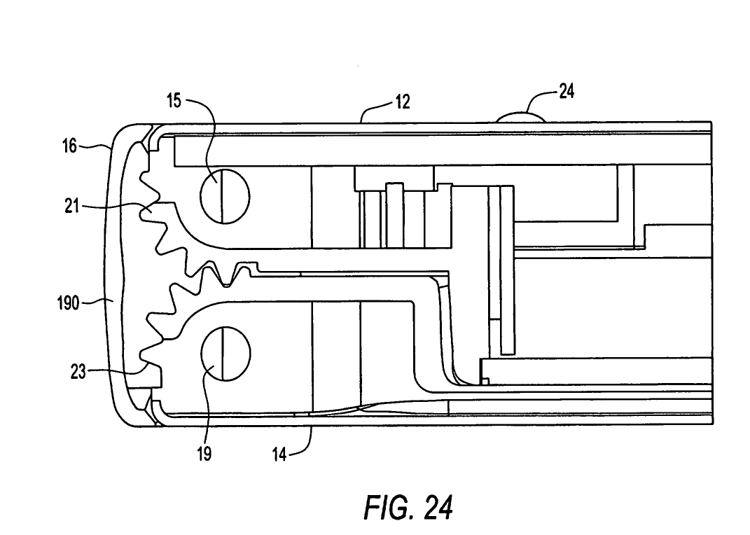

With reference to the drawings, a folding keyboard, shown fully folded in FIG. 1, is designated generally as 10. It comprises keyboard halves 12, 14. The keyboard halves 12, 14 are hinged by hinge 16 so that the keyboard halves 12, 14 can be folded as shown in FIG. 1. The preferred dimensions for keyboard 10 are such that the fully folded dimensions are approximately the same as the dimensions of a PDA. The bottom surfaces 18, 20 of keyboard halves 12, 14 (see FIG. 2) have rubber legs 22 to support the keyboard in the open position. Rubber dimples 24 are provided on lower surface 18 of half 12 to cushion and position the PDA when attached and folded, and depression 26 is provided on lower surface 18 of half 12 to receive a projecting element of the PDA when attached and folded. Spring-biased latch buttons 28 secure halves 12, 14 in folded configuration until released. Each keyboard half 12, 14 is secured to hinge 16 at pivot axles 13, 15, 17, 19 (see FIGS. 3, 16, 18, 19). To maintain alignment of keyboard halves 12, 14, intermeshed gear elements 21, 23 (FIGS. 3, 23 and 24) are provided. The gear elements mesh as the respective halves rotate to ensure that the halves rotate in unison.

FIG. 3 shows keyboard 10 fully unfolded. Keyboard 10 has an array of keys 30 in three rows 32, 34, 36 of letter keys laid out as in a QWERTY keyboard. The keys in the center or “home” row 34 (ASDFGHJKL;′) are 16 mm square with 1 mm spacing between keys giving them a 17 mm pitch measured center to center horizontally (that is, in the direction parallel to the length of the center row). The top row 32 (QWERTYUIOP/) and bottom row 36 (ZXCVBNM,.) are the same horizontal dimensions as the center row but are only about 50% of the vertical dimension of the keys in the center row, namely about 9 mm.

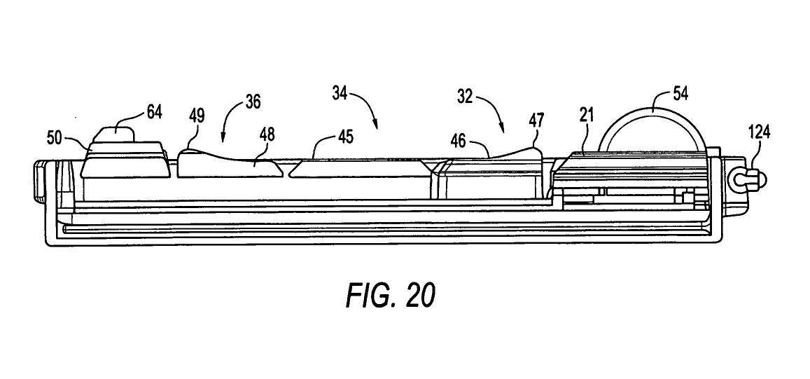

In order to facilitate a typist utilizing the same finger action as that employed on a QWERTY keyboard, the top and bottom rows of keys 32, 36 preferably have a scalloped or contoured upper surface 46, 48 (see FIG. 20) whereby the upper edge 47 of keys in row 32 and the lower edge 49 of keys in row 36 is raised above the surface 45 of center row 30. Thus, when a typist types on keyboard 10 he/she will use the same finger action as for a standard keyboard, but to prevent the typist from missing the upper and lower keys, the upper surfaces of the top and bottom rows 32, 36 are shaped to prevent the fingers from overrunning the keys by curving the upper or lower edges of the keys in the top and bottom rows upwardly. To be useful, it has been found that the height of upper edges 47 and 49 should be approximately 1.5 nm. higher than the surface 45 of row 30. Further embodiments of the configuration of the keys for the top and bottom rows 32, 36 are shown in the present inventor's co-pending International applications PCT/CA01/00983 and PCT/CA01/01047 filed Jul. 18, 2001.

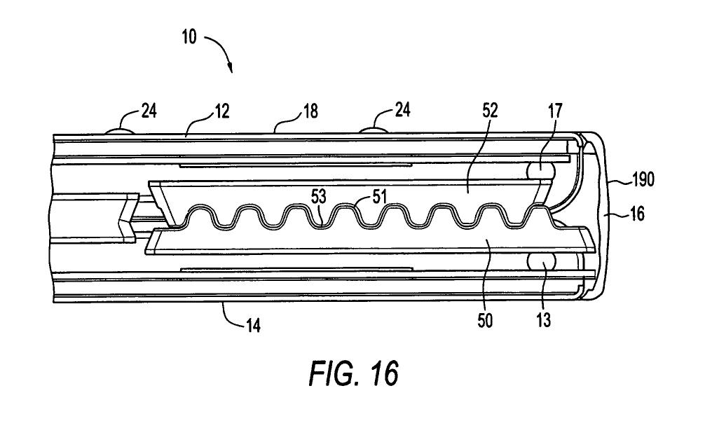

To provide better activation of the space bars 50, 52 by the typist's thumbs, the upper surfaces 51, 53 of space bars 50, 52 are raised, but corrugated. The corrugations are offset so that they mesh when folded as shown in FIG. 16. This provides a higher effective striking surface than would otherwise be permitted by the reduced thickness of the folding keyboard 10.

Battery 54 is installed in battery cavity 56. Preferably a 1.5 volt AAA battery is used. A corresponding cavity 58 is formed on half 14 to receive battery 54 when the keyboard is folded. To preserve power the battery 54 is programed to always be in sleep mode (consuming less than 10 micro-amperes) unless the keyboard is operating (at least one key is depressed). To avoid accidental draining of the battery, a sleep mode also turns the keyboard off when any key is depressed for more than 10 minutes.

Pins 60 extend upwardly from the surface of keyboard half 12 to fit into corresponding depressions 62 in half 14 when the keyboard 10 is folded for purposes of alignment. Latch hooks 64, which are moved in the plane of the keyboard 10 by spring-biased latches 28, engage slots 66 to releasably secure keyboard halves 12, 14 in the folded configuration. A cup-like stylus holder 68 both acts as a storage holder for the stylus stand described in further detail below, and aligns in depression 69 when the keyboard is folded.

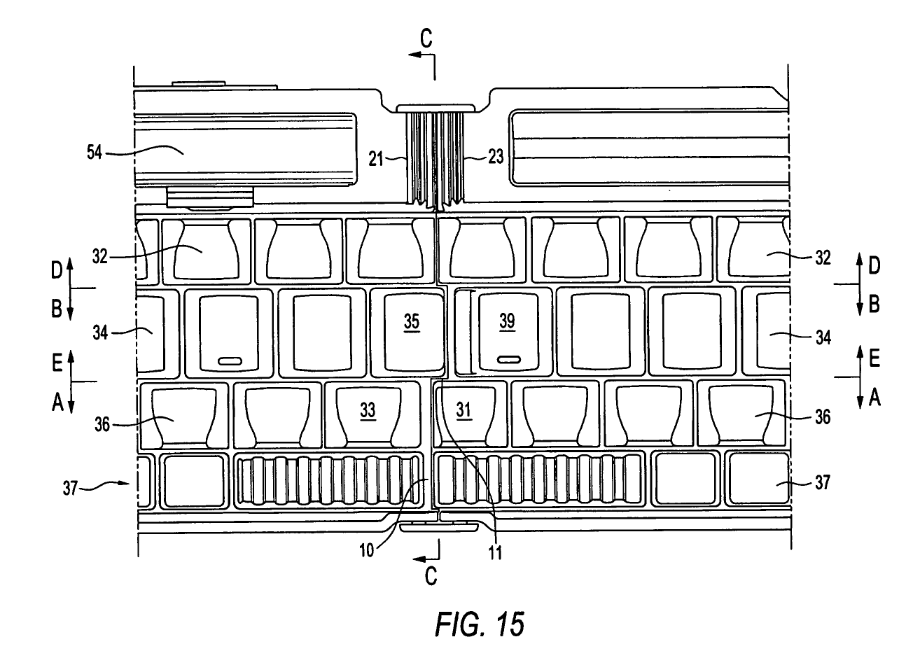

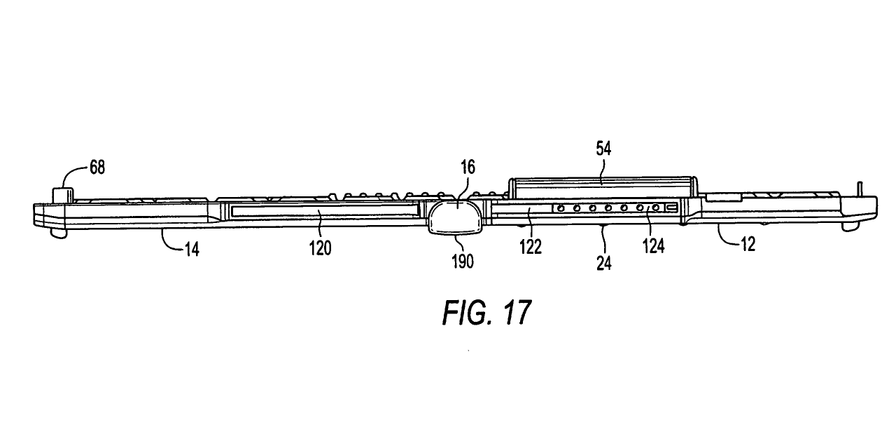

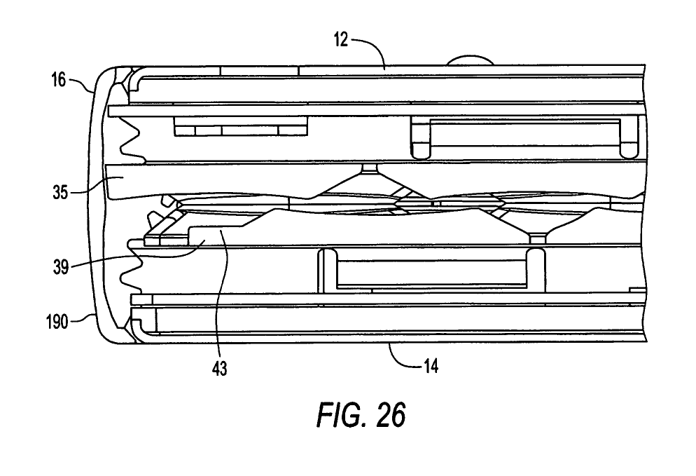

As shown in FIGS. 15-20, the edges of the keyboard halves 12, 14 in the vicinity of key rows 36 and 37 is positioned a short distance to the left of the actual center line C-C. The central split of the keyboard halves 12, 14 in the vicinity of key row 34 is positioned a short distance to the right of the actual center line C-C. This permits the keys to be properly positioned but still allows them to clear when being folded. The “N” key 31 and “H” key 35 extend over the center line C-C of the open keyboard, and the “B” key 33 and “J” key 39 have extended edges 41, 43 to fill the enlarged gaps in those areas. Also to accommodate the extensions of keys 31 and 35 when folding, the outer edge or spline 190 of hinge 16 curves outwardly to provide a space, as shown in FIGS. 16 and 26.

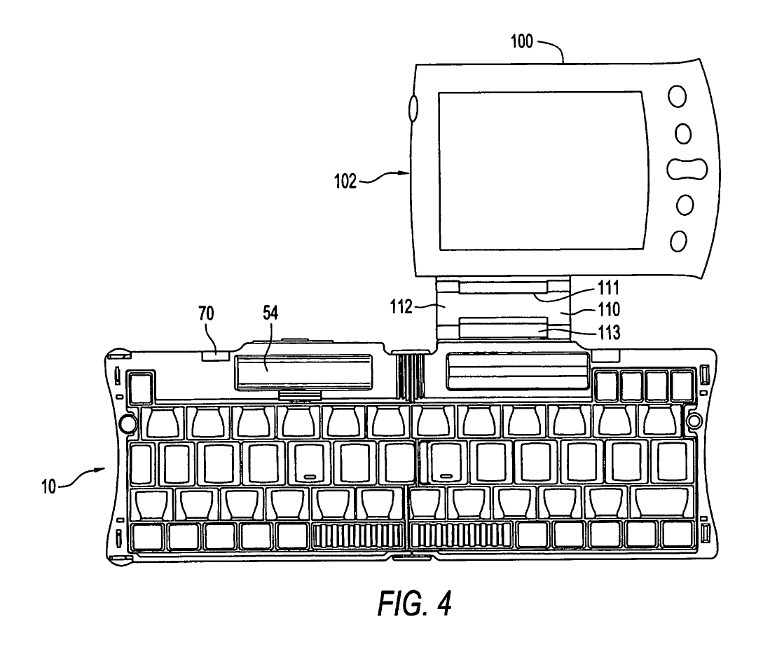

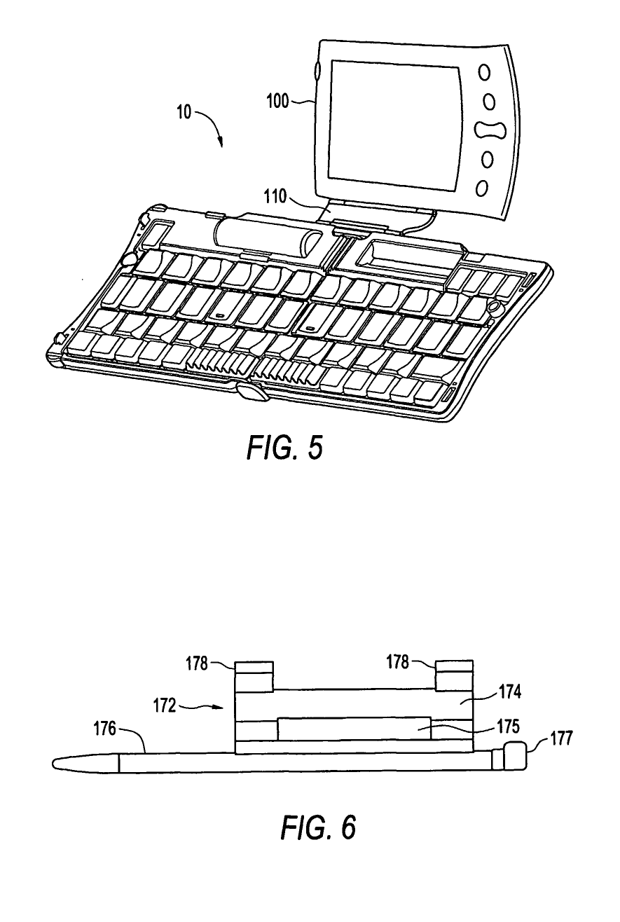

Keyboard 10 communicates to the PDA 100 by infrared (IR) communication from IR port 70 on keyboard half 12, to the IR port 102 on PDA 100 (see FIG. 4). The IR lens (not shown) for port 70 is preferably made of polycarbonate to provide a diffuse beam which is effective up to at least one meter and at an operating angle of up to 45 degrees. In the preferred embodiment, the infrared interface conforms to the IrDA Serial Infrared Physical Layer (IRPHY) Specification V1.3 with a data rate of 9600 baud. In the configuration shown in FIGS. 4 and 5, the PDA 100 is connected to the keyboard 10 by hinge 110 as shown in FIG. 7 and as further described below. In that case, the screen display on the PDA is rotated 90 degrees, using rotational software to flip the display from portrait to landscape mode. To connect the PDA 100 to the keyboard 10 as shown in FIGS. 4 and 5, hinge 110 is used. Hinge 110 has a generally rectangular planar panel or web 112 to one edge of which is pivotally or hingedly attached by hinge 111 a surrogate stylus 114 which is sized to slide into the stylus-storing cavity of a PALM PDA. Pivotally or hingedly attached to the other edge of web 112 by hinge 113 is a cylinder 16 which is sized to slide into a receiving slot 120 on keyboard 10. Surrogate stylus 114 is first slid into the stylus-storing cavity of a PALM PDA and, as with a standard stylus, is cammed into tight relationship with the PDA by camming end 118. The connecting cylinder 116 is then slid into receiving slot 120 on keyboard half 14, either when the keyboard is folded or unfolded to place the PDA in the position shown in FIG. 4. In this position, the PDA 100 cab be folded over the folded keyboard 10. When the keyboard 10 is unfolded hinge 110 is slid to the position shown in FIG. 5 which locks the keyboard in the open position. To lock the keyboard 10 in open operating position, the cylinder 116 is then further slid into receiving slot 122 on keyboard half 12.

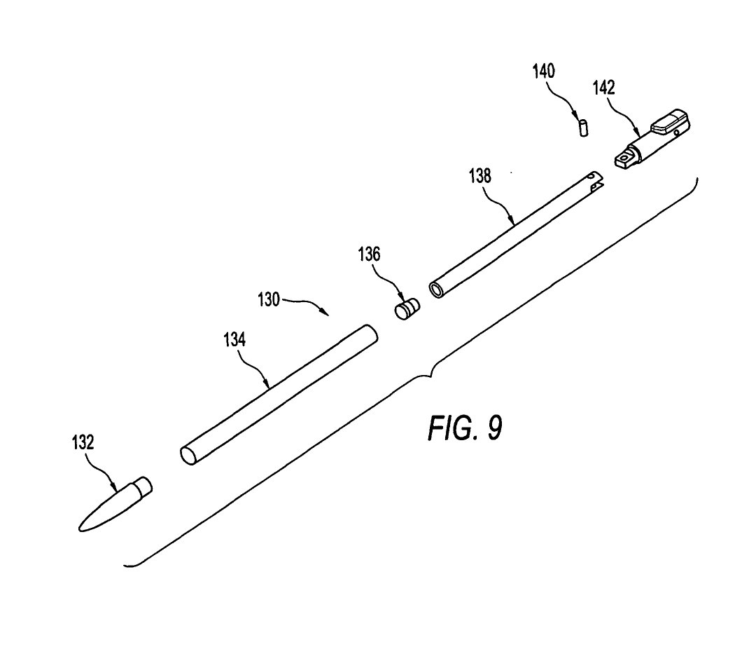

A customized pen or stylus 130 (FIG. 9), which is stored in the stylus storage cavity of the PDA 100, can be used to provide a stand for the PDA 100 to form a configuration like a laptop computer in conjunction with the keyboard as shown in FIGS. 4, 5. The stylus 130 has stylus tip 132 fixed to an outer cylindrical tube 134, and an inner cylindrical leg element 138 pivotally connected by a hinge pin 140 to stylus top 142. The end of inner leg 138 has a rubber tip 136 to contact the supporting surface. Stylus 130 is removed from the PDA 100 and outer shell 134 and tip 132 are removed and can be held for storage in cup 68 provided on keyboard 10. Top 142 is inserted into the end of the stylus cavity of PDA 100. Knob 141 prevents it from rotating. Leg 138 is pivoted 90 degrees about hinge 140 to act as a stand for the PDA 100. The length of leg 138 will determine the angle at which the PDA stands, but 45 degrees has been found to be a comfortable viewing angle.

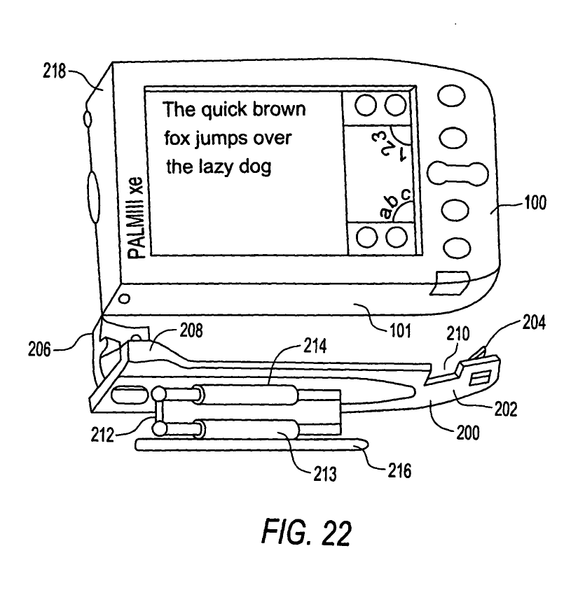

To operate the PDA in the foregoing configuration it is necessary that the PDA have a stylus port or cavity in the appropriate location (as does the PALM PDA), or a customized attachment or sled can be removably attached to the PDA in order to receive the stylus portion 114 of hinge 110 in the appropriate location and orientation. Such a custom sled 200 is shown in FIG. 22. It comprises a semi-rigid plastic body 202 sized and shaped to snap-fit over the edge 101 of PDA using resilient flanges 204, 206, 208 and cut-outs 210 to accommodate features of the PDA 100. It has an attached hinge, pivotally attached at hinge joint 214, and pivotally or hingedly attached to the other edge of hinge 212 by hinge 213 is a cylinder 216 which is sized to slide into a receiving slot 120 on keyboard 10. Since all PDA's have a stylus cavity at location 218 the sled 200 allows all PDA's to be used with the stylus 130 in the first operating configuration described above.

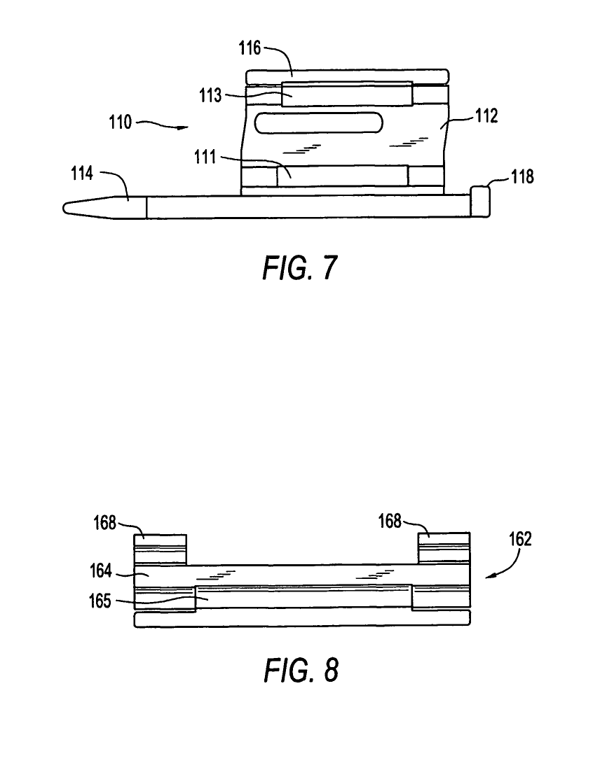

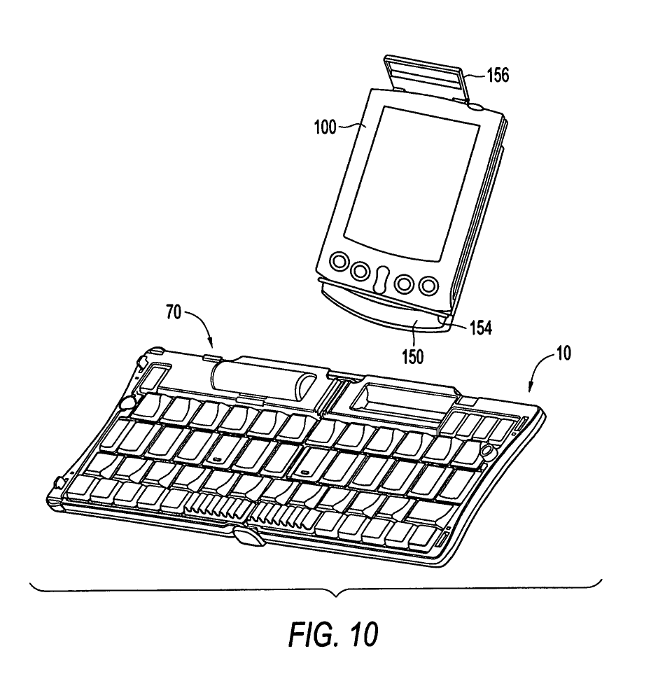

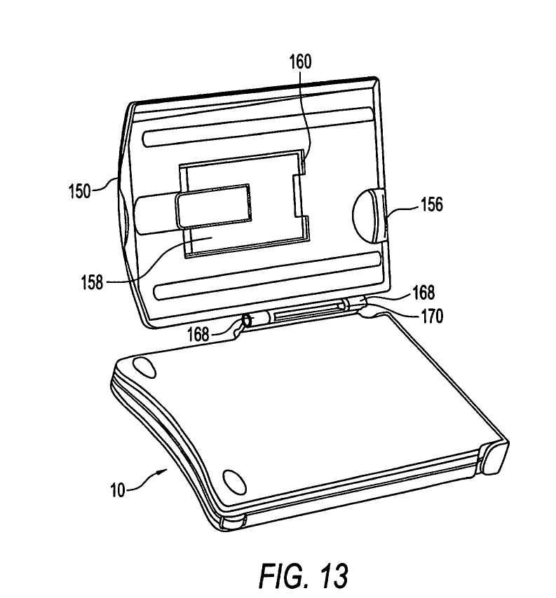

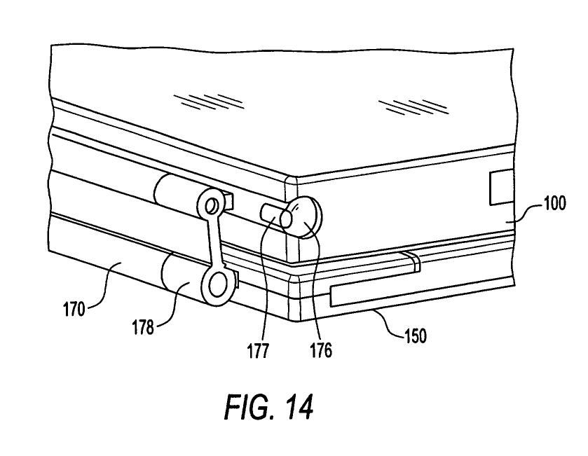

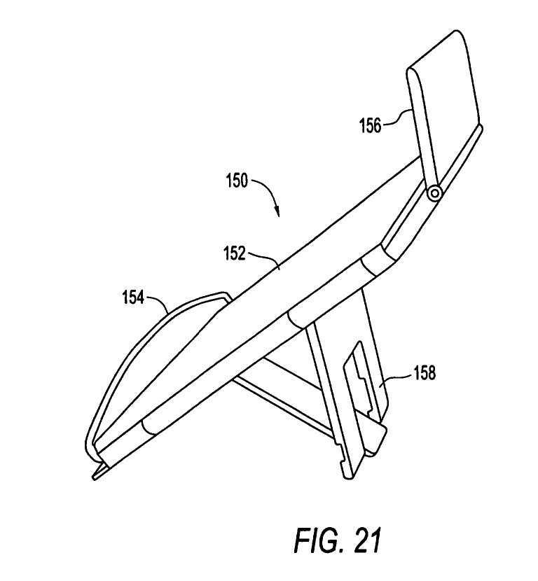

A second configuration shown in FIG. 10 is also provided for operation of the invention. In this configuration the PDA 110 is not connected to the keyboard but rather is separately supported on a mounting stand 150. Keyboard 10 is opened as previously but is locked in the open position by sliding locking bar 124 to extend from slot 122 on half 12 into slot 120 on half 14. Stand 150 (FIGS. 13 and 21) has a generally rectangular body 152 which supports the PDA 100. A rotatable wire retainer 154 snaps in place in a depression in the stand or can be rotated at right angles to the stand to retain the PDA in place as shown in FIG. 10. In order to receive the IR signal in the port 102 of PDA 100 a reflector 156 is provided which slides out of the interior of stand 150. Reflector 156 comprises a foil sheet adhered to a plastic backplate and is hinged with a ratchet connection so that it can be adjusted to the appropriate angle to deflect the IR signal from port 70 to port 102. Stand 150 has a retractable support leg 158 which folds flush against the stand or pivots outwardly on hinge 160 to act as a stand at a comfortable angle for viewing. Stand 150 can also be hingedly attached to keyboard 10 by hinge 162 (FIG. 8) or to PDA 100 by hinge 172 (FIG. 6). Hinge 162 has a narrow rectangular panel or web 164. Pivotally or hingedly attached to one edge of web 164 by hinge 165 is a cylinder 166 which is sized to slide into the receiving slot 120 on keyboard 10. Connected to the opposite edge of web 164 are hollow sleeves 168, which are open along one side to pivotally snap over the ends of cylinder 170 attached to stand 150, thereby allowing the stand to be folded over the keyboard 10 for carrying purposes. Hinge 172 has a narrow rectangular panel or web 174. Pivotally or hingedly attached to one edge of web 174 by hinge 175 is a surrogate stylus 176 which is sized to slide into the stylus storing cavity in a PDA. Connected to the opposite edge of web 174 are hollow sleeves 178 which pivotally receive the ends of cylinder 170 attached to stand 150, thereby allowing the stand to be folded over the PDA 100 for carrying purposes (see FIG. 14). Protrusion 177 prevents the stylus from turning. To set the PDA up on the stand in this configuration it is simply necessary to rotate the stand 150 around to the back of the PDA and pivot the retractable support leg 158 outwardly on hinge 160 to act as a stand at a comfortable angle for viewing.

The keyboard 10 uses scissor-type keyswitches. To minimize the thickness of the keyboard 10 when folded, the keys 30 are compressed or squeezed to 50% of their maximum depression between halves 12 and 14 through contact with the keys on the opposing half, and latch 28 connected to hook 64 (FIGS. 1 and 3) locks the halves in the closed configuration until released.

To provide a reduced number of keys and in fact remove the need for the top row of keys found in standard computer keyboards, three color-coded activation keys 38, 40, 42 are provided and programmed so that the same key can be used to type letters, numbers or punctuation or other functions. Activating “Punctuation” key 38 causes depression of a key to type the associated punctuation symbol. Activating “Numlock” key 40 causes depression of a key to type the associated numeric symbol. Activating “Function” key 42 causes depression of a key to activate an associated function. The activation keys are activated by depressing them once and are similarly de-activated by depressing once. For example to type the numeral “4”, the user depresses Numlock key 40, then hits letter key “R”. To type the punctuation sign “{”, the user depresses Punctuation key 38, then letter key “J”. To type the “Esc” key, the user depresses Function key 42, then the “tab” key.

The keyboard 10 provides four “hot keys” 44 to perform handheld stylus functions “Calendar”, “Contacts”, “To Do” and “Memo”. Activating the Function key accesses four further stylus functions, “Mail”, “Home”, “Calculation” and “Find”.

The Numlock key also activates the calculator keys, causing selected keystrokes to activate calculator functions in the standard way. For example, after activating Numlock the “+−* /” keys provide the addition, subtraction, multiplication and division functions. Keyboard 10 also provides the conventional keyboard shortcuts for selecting text and moving the cursor on the hand-held in conformity with the guidelines specified by the PDA manufacturers. For example, “Shift-Right arrow” highlights the character to the right of the cursor. “Ctrl-Right arrow” moves the cursor forward one word. “Fn-Up arrow” scrolls up. “Cmd-Right arrow” moves the cursor to the end of the line. “Ctrl-x” cuts selected text, etc. Key combinations are also programmed to generate extended characters and accents in the conventional way prescribed by PDA manufacturers. For example, “Alt-b” generates the Greek letter Beta, etc.

Keyboard 10 is preferably not device specific and so operates with various popular platforms such as PALM OS and Windows CE/PocketPC. In operation, the keyboard driver software is first installed on the handheld device. For PALM OS devices this is done using a personal computer and the HotSync operation and for Windows CE the ActiveSync operation is performed. The keyboard driver software is loaded on the personal computer and is installed on the handheld using the HotSync or ActiveSync operations. An icon is provided on the handheld screen which enables the keyboard software when tapped by the stylus. Alternatively the driver software may be loaded on the keyboard and transferred to the handheld directly from the keybaord to the handheld using the IR port. If the configuration shown in FIGS. 4 and 5 will be used, then rotational software to rotate the screen is also activated and a Screen Rotation Selection Box is provided to allow the user to change the screen orientation. Keyboard 10 is then opened by pressing latch buttons 28 and the battery is installed. If the keyboard is to be used in the “pocket computer” configuration shown in FIGS. 4 and 5, then hinge 110 is connected to the PDA 100 and keyboard 10 as described above. The handheld can then be transported with keyboard 10 attached by folding the handheld 100 over the folded keyboard from the configuration shown in FIG. 4. Alternatively the handheld is supported on stand 150 and reflector 150 is adjusted to fit the height of the handheld (FIG. 10). In this case the stand can either be folded with the keyboard 10 using hinge 164 for transport or with the PDA using hinge 172.

While the present keyboard is particularly suited for handheld computers, it will also be apparent that the disclosed keyboard is useful as a data input device for other wireless applications such as desktop computers, televisions, entertainment centers, mobile computers in police vehicles or taxis, bank machines, e-mail machines and the like.

As will be apparent to those skilled in the art in the light of the foregoing disclosure, many alterations and modifications are possible in the practice of this invention without departing from the spirit or scope thereof. For example, while various means have been disclosed for supporting the handheld computer in a position whereby the respective infra-red ports of the keyboard and handheld can communicate, many other types of support will also work, including supports with or without legs, legged supports with three or more legs, cradles, platforms, slotted supports, deformable supports to conform to the shape of the handheld, cushions, devices from which the handheld may be hung or suspended, or even the hand of the user. While the invention has been described using infra-red communication, other wireless forms of communication such as radio frequency (RF) will also be useful in the invention. Accordingly, the scope of the invention is to be construed in accordance with the substance defined by the following claims.

What is claimed is:

1. A wireless keyboard for use with a handheld computer wherein said handheld computer comprises a wireless communications port, said wireless keyboard comprising a keyboard body having a plurality of keys, a wireless communications port, battery means, and means for supporting said handheld computer in a position whereby said wireless communication ports of the keyboard and handheld computer are able to communicate with one another.

2. The wireless keyboard of claim 1 wherein said wireless communication ports are infra-red communications ports.

3. The wireless keyboard of claim 1 wherein said wireless communication ports are radio frequency communications ports.

4. The wireless keyboard of claim 2 wherein said means for supporting comprises a stand on which said handheld computer can be removably mounted, and means for reflecting an infrared signal from said infra-red communications port on said keyboard to said infra-red communications port on said handheld computer.

5. The wireless keyboard of claim 1 wherein said means for supporting comprises a hinge adapted to be removably and pivotally attached along one side thereof to said keyboard body and adapted to be removably and pivotally attached along the opposite side thereof to said handheld computer.

6. The wireless keyboard of claim 5 wherein said handheld computer is supported relative to said keyboard in an orientation rotated 90 degrees to its normal operating orientation.

7. The wireless keyboard of claim 6 wherein said means for supporting comprises a leg adapted to be removably attached at one end thereof to said handheld computer.

8. The wireless keyboard of claim 7 wherein said handheld computer comprises a stylus storage compartment and said leg is adapted to be stored in said stylus storage compartment.

9. The wireless keyboard of claim 1 wherein said keyboard comprises a plurality of keys generally corresponding to the keys of a standard keyboard comprising three parallel, lengthwise rows of keys forming a central row, an upper row and a lower row, and comprising two halves hingedly connected along a fold line extending transversely across said keyboard, each half thereby comprising a portion of said plurality of keys, whereby said keyboard is folded from a first open position in which said plurality of keys forms said generally standard personal computer keyboard, to a closed position in which said two halves are in opposed parallel relationship and wherein said central row comprises keys of standard size, and said upper and lower rows comprise keys which are reduced in size in the transverse direction.

10. The wireless keyboard of claim 9 wherein said reduced size keys comprise keys which have upstanding edges along the top and bottom edges thereof respectively which are raised above the upper surface of said central row.

11. The wireless keyboard of claim 10 wherein said reduced size keys comprise keys which have a curved upper surface.

12. The wireless keyboard of claim 10 wherein said reduced size keys comprise keys which have a uniformly sloping upper surface.

13. The wireless keyboard of claim 10 wherein said reduced size keys comprise keys which have an upper surface which forms an angle less than 180 degrees with the plane of said central row.

14. The wireless keyboard of claim 10 wherein said reduced size keys comprise keys which have upper horizontal surface portions which are raised above said central row.

15. The wireless keyboard of claim 9 further comprising hinge means for hingedly attaching a handheld computer.

16. The wireless keyboard of claim 15 further comprising means for supporting a handheld computer when said handheld computer is attached to said folding keyboard.

17. The wireless keyboard of claim 9 wherein said reduced size keys comprise keys which are configured to redirect a finger of a typist to the surface of the key.

18. The wireless keyboard of claim 9 wherein said reduced size keys comprise keys which have an upper surface a portion of which slopes upwardly away from said center row.

19. The wireless keyboard of claim 9 comprising two keys on opposing halves which comprise complementary uneven upper surfaces which mesh when folded to provide a higher effective upper surface when unfolded and a reduced thickness when folded.

20. The wireless keyboard of claim 9 wherein said means for supporting a handheld computer when said handheld computer is attached to said folding keyboard comprises a stylus-shaped element having a first end sized to fit in a stylus-receiving cavity of a handheld computer, and a rigid elongated element pivotally connected thereto.

21. A folding keyboard comprising a plurality of keys generally corresponding to the keys of a standard personal computer keyboard comprising three parallel, lengthwise rows of keys forming a central row, an upper row and a lower row, and comprising two halves hingedly connected along a fold line extending transversely across said keyboard, each half thereby comprising a portion of said plurality of keys, whereby said keyboard is folded from a first open position in which said plurality of keys forms said generally standard personal computer keyboard, to a closed position in which said two halves are in opposed parallel relationship and wherein said central row comprises keys of standard size, and said upper and lower rows comprise keys which are reduced in size in the transverse direction.

22. The folding keyboard of claim 21 wherein said reduced size keys comprise keys which are less than 75% of the standard dimension in the transverse dimension.

23. The folding keyboard of claim 21 wherein said reduced size keys comprise keys which are less than 50% of the standard dimension in the transverse dimension.

24. The folding keyboard of claim 21 wherein said reduced size keys comprise keys which have upstanding edges along the top and bottom edges thereof respectively which are raised above the upper surface of said central row.

25. The folding keyboard of claim 24 wherein said reduced size keys comprise keys which have a curved upper surface.

26. The folding keyboard of claim 24 wherein said reduced size keys comprise keys which have a uniformly sloping upper surface.

27. The folding keyboard of claim 24 wherein said reduced size keys comprise keys which have an upper surface which forms an angle less than 180 degrees with the plane of said central row.

28. The folding keyboard of claim 24 wherein said reduced size keys comprise keys which have upper horizontal surface portions which are raised above said central row.

29. The folding keyboard of claim 24 further comprising infrared means for communicating with a handheld computer.

30. The folding keyboard of claim 21 further comprising hinge means for hingedly attaching a handheld computer.

31. The folding keyboard of claim 30 further comprising means for supporting a handheld computer when said handheld computer is attached to said folding keyboard.

32. The folding keyboard of claim 21 wherein said reduced size keys comprise keys which are configured to redirect a finger of a typist to the surface of the key.

33. The folding keyboard of claim 21 wherein said reduced size keys comprise keys which have an upper surface a portion of which slopes upwardly away from said center row.

34. The folding keyboard of claim 21 wherein said reduced size keys comprise keys which comprise a horizontal surface hingedly connected to a vertically extending hinged tab.

35. The folding keyboard of claim 21 wherein said means for supporting a handheld computer when said handheld computer is attached to said folding keyboard comprises a stylus-shaped element having a first end sized to fit in a stylus-receiving cavity of a handheld computer, and a rigid elongated element pivotally connected thereto.

36. The folding keyboard of claim 21 comprising two keys on opposing halves which comprise complementary uneven upper surfaces which mesh when folded to provide a higher effective upper surface when unfolded and a reduced thickness when folded.

37. The folding keyboard of claim 21 for use with a handheld computer wherein said handheld computer comprises a wireless communications port, said folding keyboard comprising a keyboard body having a plurality of keys, a wireless communications port, battery means, and means for supporting said handheld computer in a position whereby said wireless communication ports of the keyboard and handheld are able to communicate with one another.

38. The folding keyboard of claim 37 wherein said wireless communication ports are infra-red communications ports.

39. The folding keyboard of claim 37 wherein said wireless communication ports are radio frequency communications ports.

40. The folding keyboard of claim 38 wherein said means for supporting comprises a stand on which said handheld computer can be removably mounted, and means for reflecting an infrared signal from said infra-red communications port on said keyboard to said infra-red communications port on said handheld computer.

41. The folding keyboard of claim 37 wherein said means for supporting comprises a hinge adapted to be removably and pivotally attached along one side thereof to said keyboard body and adapted to be removably and pivotally attached along the opposite side thereof to said handheld computer.

42. The folding keyboard of claim 41 wherein said handheld computer is supported relative to said keyboard in an orientation rotated 90 degrees to its normal operating orientation.

43. The folding keyboard of claim 42 wherein said means for supporting comprises a leg adapted to be removably attached at one end thereof to said handheld computer.

44. The folding keyboard of claim 43 wherein said handheld computer comprises a stylus storage compartment and said leg is adapted to be stored in said stylus storage compartment.

45. In combination, a hand-held computer, and a wireless folding keyboard, wherein said handheld computer comprises a wireless communications port, said wireless keyboard comprising a keyboard body having a plurality of keys, a wireless communications port and means for supporting said handheld computer in a position whereby said wireless communication ports of the keyboard and handheld are able to communicate with one another.

46. A wireless folding keyboard, wherein said handheld computer comprises a wireless communications port, said wireless keyboard comprising a keyboard body having a plurality of keys, a wireless communications port and means for supporting said handheld computer in a position whereby said wireless communication ports of the keyboard and handheld computer are able to communicate with one another.

47. The wireless keyboard of claim 5 wherein said means for supporting comprises removable means for attachment to said handheld computer comprising a stylus-receiving cavity, and a hinge adapted to be removably and pivotally attached along one side thereof to said keyboard body and adapted to be removably and pivotally attached along the opposite side thereof to said removable attachment means.

48. The folding keyboard of claim 21 wherein said first and second halves of said keyboard are hingedly connected by a hinge element having a transverse spline piece and hinging plates extending generally perpendicularly from each end of said spline piece, wherein each hinging plate has first and second hinge pins which rotate in said first and second halves respectively.

49. The folding keyboard of claim 48 wherein said spline piece is curved outwardly to receive extending portions of keys when said keyboard is folded.

49. The folding keyboard of claim 48 wherein said first and second halves have respective meshed gear elements which rotate in unison when said keyboard is folded.
